(19) United States
(12) Patent Application Publication
(10) Pub. No.: US 2012/0268492 A1
(43) Pub. Date: Oct. 25, 2012

(54) IMAGE PROCESSING APPARATUS, IMAGE PROCESSING METHOD, AND PROGRAM

(76) Inventor: Shunichi KASAHARA, Kanagawa (JP)

(21) Appl. No.: 13/445,431

(22) Filed: Apr. 12, 2012

(30) Foreign Application Priority Data
Apr. 19, 2011 (JP) 2011-093089

(51) Int. Cl. G09G 5/00

(52) U.S. Cl. 345/633

(57) ABSTRACT

Provided is an image processing apparatus including an image acquisition unit for acquiring an input image, a selection unit for selecting a recognition method of an object shown in the input image from a plurality of recognition methods, a recognition unit for recognising the object shown in the input image using the recognition method selected by the selection unit, and a display control unit for superimposing a virtual object that is associated with the object recognised by the recognition unit onto the input image and displaying the virtual object. The display control unit changes display of the virtual object according to the recognition method selected by the selection unit.

### BACKGROUND

The present disclosure relates to an image processing apparatus, an image processing method, and a program.

In recent years, a technology called Augmented Reality (AR) that superimposes additional information onto the real world and presents it to users is gaining attention. Information to be presented to the users in the AR technology may be visualized by using various types of virtual objects. For example, in the case of using the AR technology to bring attention to an object in the real world, a virtual object (for example, a marker) for bringing attention to the object may be superimposed onto the object in the real world (or around the object) or the like and the virtual object may be displayed. A user may turn his/her attention to an object calling for attention by viewing the virtual object. An object calling for attention may be an announcement, an advertisement or the like, for example.

Such an object may be recognised based on a captured image obtained by an imaging device capturing the real world. Here, the same recognition method is not used at all times as the method of object recognition, and it may be changed as appropriate according to the situation. For example, there is disclosed a technology of increasing the accuracy of object recognition by evaluating the accuracy of object recognition and, for example, modifying a parameter used for recognition or changing a recognition algorithm based on the evaluation result (for example, see JP 2001-175860A).

### SUMMARY

However, a technology of giving a user feedback on what kind of recognition method is used is so far not disclosed. Recognition methods differ from each other in the processing cost or the attainable accuracy. Accordingly, if feedback is given to a user on the recognition method, it would be useful particularly in the case where there are a plurality of recognition methods that may be possibly used. As one example, a user may judge, based on the feedback, the position or attitude of a virtual object that is currently displayed or the reliability of the contents of information that is presented. As another example, a user may wait, according to the feedback, until a recognition method with which a high recognition accuracy can be expected becomes usable and then operate a virtual object. Therefore, it is desirable that a technology is realized which is capable of easily giving a user feedback on a recognition method that is used in object recognition.

According to an embodiment of the present disclosure, there is provided an image processing apparatus which includes an image acquisition unit for acquiring an input image, a selection unit for selecting a recognition method of an object shown in the input image from a plurality of recognition methods, a recognition unit for recognising the object shown in the input image using the recognition method selected by the selection unit, and a display control unit for superimposing a virtual object that is associated with the object recognised by the recognition unit onto the input image and displaying the virtual object. The display control unit changes display of the virtual object according to the recognition method selected by the selection unit.

As described above, according to the present disclosure, feedback can be easily given to a user on a recognition method that is used in object recognition.

### BRIEF DESCRIPTION OF THE DRAWINGS

FIG. 1 is a diagram for describing an overview of an image processing apparatus according to an embodiment of the present disclosure;

FIG. 2 is a block diagram showing a hardware configuration of the image processing apparatus according to the embodiment;

FIG. 3 is a block diagram showing an example of a structure of a function realized by a control unit;

FIG. 4 is a diagram for describing a function of selecting a recognition method from a plurality of recognition methods;

FIG. 5 is a block diagram showing another example of the structure of a function realized by the control unit;

FIG. 6 is a diagram for describing a first example regarding a plurality of recognition methods;

FIG. 7 is a diagram for describing a second example regarding a plurality of recognition methods;

FIG. 8 is a diagram for describing a third example regarding a plurality of recognition methods;

FIG. 9 is a flow chart showing a flow of a recognition process of an object;

FIG. 10 is a diagram showing an example display of a virtual object according to a selected recognition method;

FIG. 11 is a diagram showing an example display of a virtual object according to a selected recognition method; and

FIG. 12 is a flow chart showing a flow of a display control process of an output image.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and configuration are denoted with the same reference numerals, and repeated explanation of these structural elements is omitted.

Also, an explanation will be given in the following order.

1. Overview of Image Processing Apparatus

2. Example Hardware Configuration

3. Function of Information Processing Apparatus
3-1. Image Acquisition Unit
3-2. Detection Unit
3-3. Selection Unit
3-4. Recognition Unit
3-5. Flow of Recognition Process
3-6. Display Control Unit
3-7. Flow of Display Control Process

4. Summary

<1. Overview of Image Processing Apparatus>

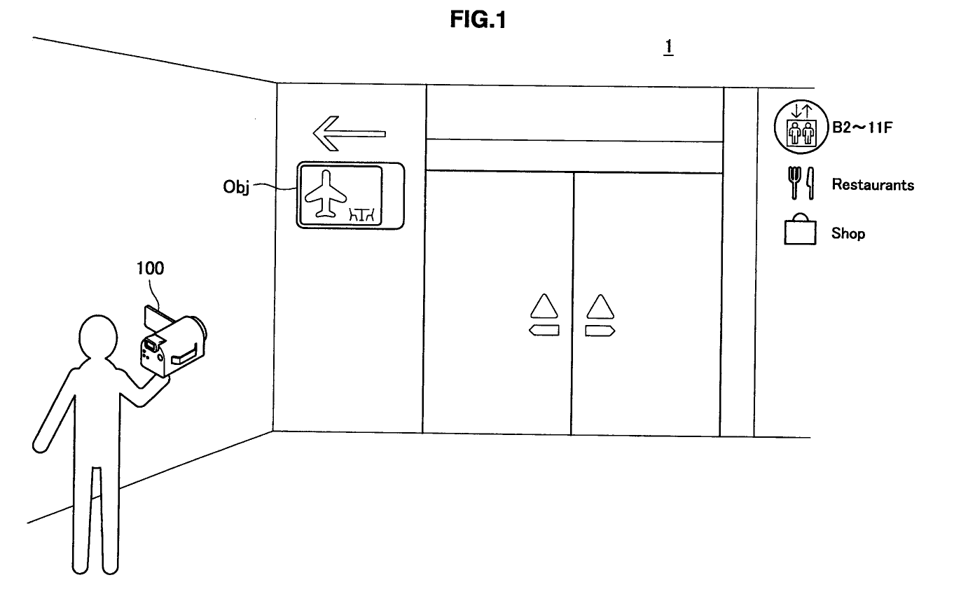

FIG. 1 is a diagram for describing an overview of an image processing apparatus according to an embodiment of the present disclosure. A real space 1 where a user having an image processing apparatus 100 according to an embodiment of the present disclosure exists is shown in FIG. 1.

Referring to FIG. 1, an object Obj exists within the real space 1. The object Obj is an object that the user should pay attention to, for example, and typically, is a sign indicating the location of a destination or the like as shown in FIG. 1, but it may also be an advertisement or the like advertising a product or an event or other objects. Also, in the example shown in FIG. 1, the object Obj is installed on the wall, but it may also be installed on the ceiling, the floor or the like. Furthermore, the real space 1 is not limited to the example shown in FIG. 1, and may be an indoor environment or an outdoor environment.

The image processing apparatus 100 captures the inside of a real space and performs image processing according to the present embodiment which will be described later. In FIG. 1, a video camera is shown as an example of the image processing apparatus 100, but the image processing apparatus 100 is not limited to such an example. For example, the image processing apparatus 100 may be an information processing apparatus, such as a personal computer (PC), a mobile terminal or a digital home appliance, capable of acquiring an image from an imaging device such as the video camera. Also, the image processing apparatus 100 is not necessarily be held by a user as shown in FIG. 1. For example, the image processing apparatus 100 may be fixedly installed at an arbitrary position, or may be installed in a robot or the like having a camera as the vision.

When a captured image is taken as an input image and an object Obj is recognised by the image processing apparatus 100 based on the input image, a virtual object associated with the recognised object Obj may be superimposed onto the input image and displayed. The virtual object is a virtual object (for example, a marker) for bringing attention to the recognised object Obj, for example, and may be superimposed onto the object Obj (or onto the periphery of the object Obj) or the like in the input image. By viewing the virtual object, a user can bring his/her attention to the object Obj that is calling for attention.

The same recognition method is not used at all times as the method of object recognition, and it may be changed as appropriate according to the situation. The image processing apparatus 100 according to the embodiment of the present disclosure is capable of making a user perceive the recognition method of an object by a mechanism which will be described in detail from the following section.

<2. Example Hardware Configuration>

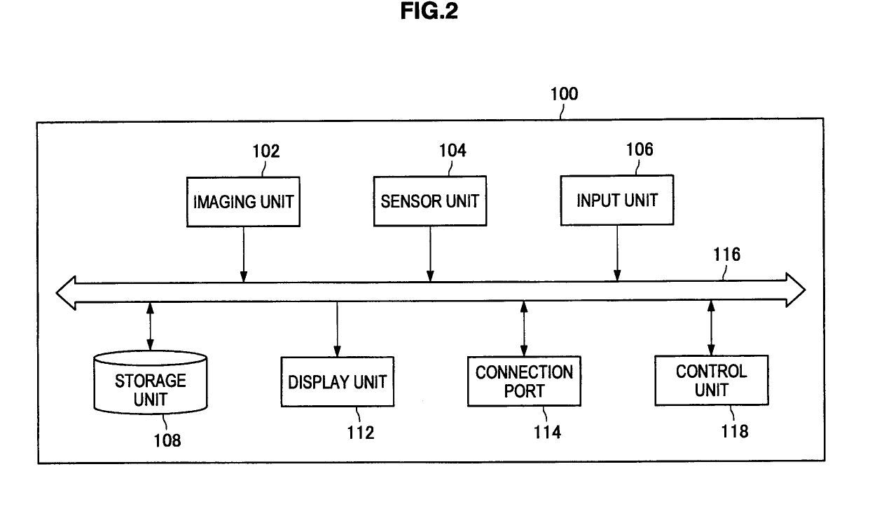

FIG. 2 is a block diagram showing an example of a hardware configuration of the image processing apparatus 100 according to the embodiment of the present disclosure. Referring to FIG. 2, the image processing apparatus 100 includes an imaging unit 102, a sensor unit 104, an input unit 106, a storage unit 108, a display unit 112, a connection port 114, a bus 116 and a control unit 118.

(Imaging Unit)

The imaging unit 102 is a camera module corresponding to the imaging device, for example. The imaging unit 102 generates a captured image by capturing the real space 1 using an image sensor such as a CCD (Charge Coupled Device) or a CMOS (Complementary Metal Oxide Semiconductor). The imaging unit 102 is assumed to be a part of the image processing apparatus 100 in the embodiment of the present disclosure, but the imaging unit 102 may also be configured separately from the image processing apparatus 100.

(Sensor Unit)

The sensor unit 104 is a group of sensors for supporting recognition of the position and the attitude of the image processing apparatus 100 (the position and the attitude of the imaging unit 102). For example, the sensor unit 104 may include a GPS sensor that receives a GPS (Global Positioning System) signal and measures the latitude, the longitude and the altitude of the image processing apparatus 100. Also, the sensor unit 104 may include a positioning sensor that measures the position of the image processing apparatus 100 based on the intensity of a radio signal received from a wireless access point. Furthermore, the sensor unit 104 may include a gyro sensor that measures the tilt angle of the image processing apparatus 100, an acceleration sensor that measures the three-axis acceleration or a geomagnetic sensor that measures the orientation. Additionally, in the case the image processing apparatus 100 has a position estimation function and an attitude estimation function that are based on image recognition, the sensor unit 104 may be omitted from the configuration of the image processing apparatus 100.

(Input Unit)

The input unit 106 is an input device used by a user to operate the image processing apparatus 100 or to input information to the image processing apparatus 100. The input unit 106 may include a keyboard, a keypad, a mouse, a button, a switch or a touch panel, for example. The input unit 106 may include a gesture recognition module that recognises a gesture of a user shown in an input image. Furthermore, the input unit 106 may include a line-of-sight detection module that detects, as an user input, the line-of-sight of a user wearing a head-mounted display (HMD).

(Storage Unit)

The storage unit 108 stores programs and data used for processing by the image processing apparatus 100, by using a storage medium such as a semiconductor memory or a hard disk. For example, the storage unit 108 stores image data that is output from the imaging unit 102 and sensor data that is output from the sensor unit 104. Also, the storage unit 108 stores a feature dictionary used for object recognition and virtual object data, which is the data of a virtual object which is a display target. Furthermore, the storage unit 108 stores a recognition result that is generated as a result of object recognition.

(Display Unit)

The display unit 112 is a display module that is configured from an LCD (Liquid Crystal Display), an OLED (Organic light-Emitting Diode), a CRT (Cathode Ray Tube) or the like. An output image, which is an input image onto which a virtual object is superimposed by the image processing apparatus 100, is displayed on the screen of the display unit 112. The display unit 112 may be a part of the image processing apparatus 100, or may be configured separately from the image processing apparatus 100. Also, the display unit 112 may be an HMD worn by a user.

(Connection Port)

The connection port 114 is a port for connecting the image processing apparatus 100 to a peripheral device or a network. For example, a removable media may be connected to the connection port 114 as an additional storage medium. Also, a wired or wireless communication interface may be connected to the connection port 114. The image processing apparatus 100 is thereby enabled to acquire an image from a server on a network, for example.

(Bus)

The bus 116 interconnects the imaging unit 102, the sensor unit 104, the input unit 106, the storage unit 108, the display unit 112, the connection port 114 and the control unit 118.

(Control Unit)

The control unit 118 corresponds to a processor such as a CPU (Central Processing Unit), a DSP (Digital Signal Processor) or the like. The control unit 118 causes various functions of the image processing apparatus 100 described later to operate, by executing programs stored in the storage unit 108 or other storage medium.

<3. Function of Information Processing Apparatus>

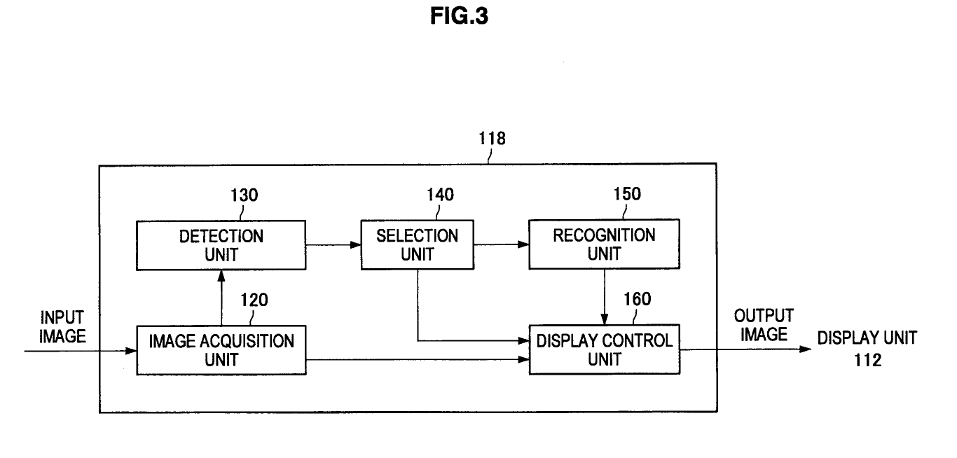

FIG. 3 is a block diagram showing an example of a structure of a function realized by the control unit 118 of the image processing apparatus 100 shown in FIG. 2. Referring to FIG. 3, the control unit 118 includes an image acquisition unit 120, a detection unit 130, a selection unit 140, a recognition unit 150 and a display control unit 160.

[3-1. Image Acquisition Unit]

The image acquisition unit 120 acquires an input image showing a real space captured using the imaging unit 102 (or other imaging device). The input image is an image showing either a location in the real space at which a virtual object is placed or an object. The image acquisition unit 120 outputs the acquired input image to the detection unit 130 and the display control unit 160. Alternatively, as will be described later, the image acquisition unit 120 does not have to output the acquired input image to the detection unit 130. For example, in the case the imaging unit 102 (or other imaging device) is continuously capturing the real space, the image acquisition unit 120 may continuously acquire input images.

[3-2. Detection Unit]

The detection unit 130 detects a parameter regarding a motion of an object shown in the input image input from the image acquisition unit 120. The parameter detected by the detection unit 130 is a parameter that is in accordance with an amount of relative movement between the image processing apparatus 100 and an object shown in the input image, for example. The detection unit 130 can acquire the amount of movement in each area of the input image by an optical flow or the like, and calculate the total sum of the amount of movement in each area as the amount of relative movement, for example. The amount of movement may be expressed by a vector, for example.

Each area of the input image may be decided in advance, for example. For example, each area of the input image may be a block (a set of pixels) in the entire input image, or a pixel in the entire input image. Alternatively, each area of the input image may not have to be decided in advance. For example, the detection unit 130 can also acquire the amount of movement of an object shown in the input image by an optical flow or the like, and calculate the amount of movement of the object as the amount of relative movement. As the optical flow, a method such as a block matching method or a gradient method may be adopted, for example.

[3-3. Selection Unit]

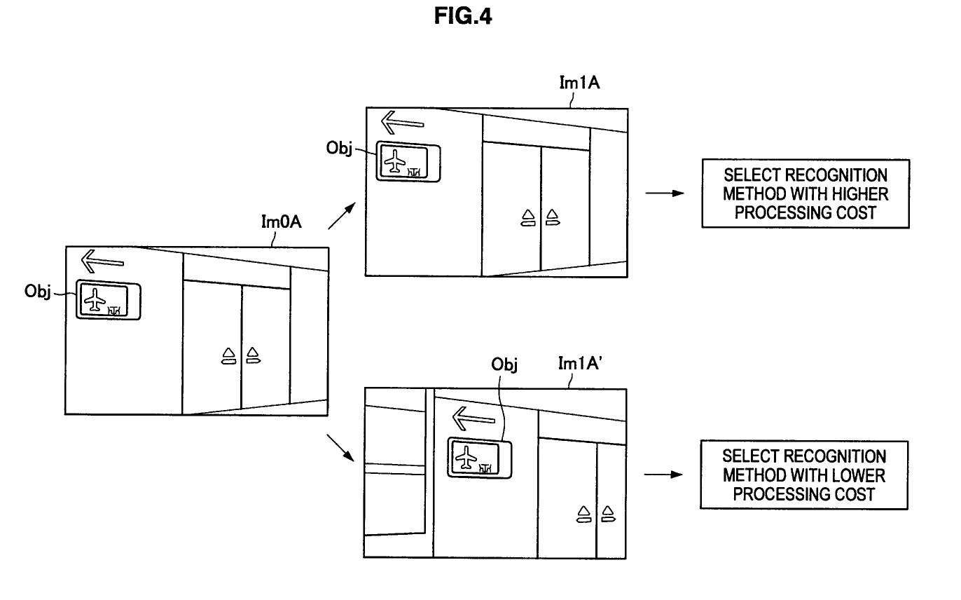

FIG. 4 is a diagram for describing a function of selecting a recognition method from a plurality of recognition methods. A function of selecting, in a case there are a plurality of methods for recognising an object, a recognition method of an object shown in an input image from the plurality of recognition methods will be described with reference to FIG. 4. The selection unit 140 can select at least one recognition method from the plurality of recognition methods.

In the case a parameter detected by the detection unit 130 indicates that no object moving at a level exceeding a predetermined level is shown in the input image, the selection unit 140 selects a recognition method with a higher processing cost. For example, a case is assumed where an input image acquired by the image acquisition unit 120 transitioned from an image Im0A to an image Im1A. In this case, since the amount of movement calculated by the detection unit 130 does not exceed a predetermined amount of movement, the selection unit 140 can determine that the parameter indicates that no object moving at a level exceeding a predetermined level is shown in the input image.

On the other hand, in the case the parameter detected by the detection unit 130 indicates that an object moving at a level exceeding a predetermined level is shown in the input image, the selection unit 140 selects a recognition method with a lower processing cost. For example, a case is assumed where an input image acquired by the image acquisition unit 120 transitioned from the image Im0A to an image Im1A′. In this case, since the amount of movement calculated by the detection unit 130 exceeds a predetermined amount of movement, the selection unit 140 can determine that the parameter indicates that an object moving at a level exceeding a predetermined level is shown in the input image.

The selection unit 140 outputs a recognition method which has been selected to the recognition unit 150 and the display control unit 160. Additionally, expressions such as a “recognition method with a higher processing cost” and a “recognition method with a lower processing cost” merely express a relative highness or lowness of a processing cost with respect to a relative relationship, and do not indicate an absolute highness or lowness of the processing cost. That is, it means that, when comparing two processing costs, one processing cost is higher than the other.

By selecting a recognition method in this manner, the processing cost for object recognition can be changed according to a parameter. For example, in the case an object moving at a level exceeding a predetermined level is shown in an input image, it is assumed that the input image is greatly blurred (that the input image is relatively unclear), and a greater emphasis may be put on the processing speed for object recognition than on the accuracy of object recognition. Then, the selection unit 140 will select a recognition method with a lower processing cost.

On the other hand, for example, in the case no object moving at a level exceeding a predetermined level is shown in an input image, it is assumed that the input image is not greatly blurred (that the input image is relatively clear), and a greater emphasis may be put on the accuracy of object recognition than on the processing speed for object recognition. Then, the selection unit 140 will select a recognition method with a higher processing cost.

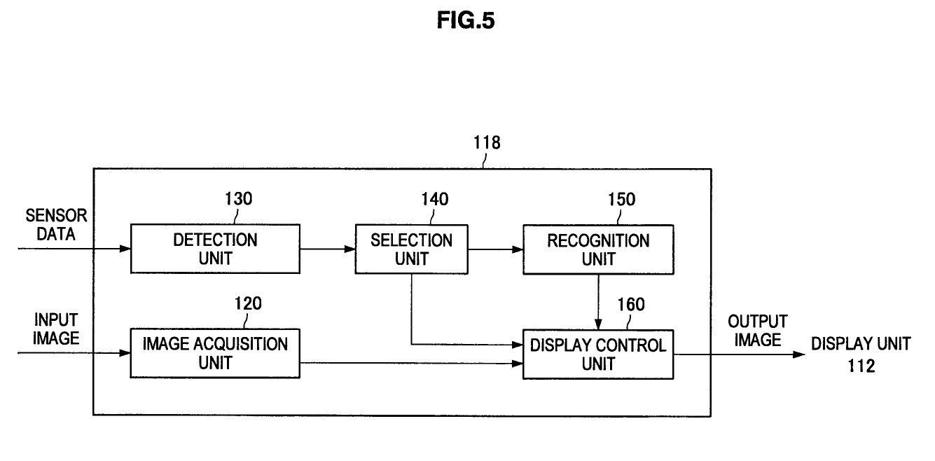

FIG. 5 is a block diagram showing another example of a structure of a function realized by the control unit 118 of the image processing apparatus 100 shown in FIG. 2. Another example of a function of selecting, in a case there are a plurality of methods for recognising an object, a recognition method of an object shown in an input image from the plurality of recognition methods will be described with reference to FIG. 5.

As described above, the detection unit 130 detects a parameter regarding a motion of an object shown in an input image input from the image acquisition unit 120. The parameter detected by the detection unit 130 is a parameter that is in accordance with an amount of absolute movement of the image processing apparatus 100, for example. In this case, the detection unit 130 may detect the sensor data detected by the sensor unit 104 as the amount of absolute movement of the image processing apparatus 100.

Furthermore, as described, above, in the case the parameter detected by the detection unit 130 indicates that no object moving at a level exceeding a predetermined level is shown in the input image, the selection unit 140 selects a recognition method with a higher processing cost. For example, it can be determined that the parameter indicates that no object moving at a level exceeding a predetermined level is shown in the input image, in the case the difference between an average value of a plurality of pieces of sensor data detected in the past and the value of the sensor data that is currently detected exceeds a predetermined value.

Alternatively, it is also possible to determine that the parameter indicates that no object moving at a level exceeding a predetermined level is shown in the input image, in the case the difference between the value of sensor data detected in the past and the value of the sensor data that is currently detected exceeds a predetermined value.

On the other hand, as described above, in the case the parameter detected by the detection unit 130 indicates that an object moving at a level exceeding a predetermined level is shown in the input image, the selection unit 140 selects a recognition method with a lower processing cost. For example, it can be determined that the parameter indicates that an object moving at a level exceeding a predetermined level is shown in the input image, in the case the difference between an average value of a plurality of pieces of sensor data detected in the past and the value of the sensor data that is currently detected does not exceed a predetermined value.

Alternatively, it is also possible to determine that the parameter indicates that an object moving at a level exceeding a predetermined level is shown in the input image, in the case the difference between the value of sensor data detected in the past and the value of the sensor data that is currently detected does not exceed a predetermined value.

[3-4. Recognition Unit]

The recognition unit 150 recognises an object shown in an input image by using a recognition method selected by the selection unit 140. The recognition unit 150 can recognise an object shown in an input image by checking each feature extracted from the input image against a feature dictionary, which is a collection of features of a known object image. For example, in the case there is a feature in the feature dictionary that matches a feature extracted from the input image, the recognition unit 150 can recognise the object by acquiring an object ID associated with the feature and the position and attitude of the object. The feature dictionary used here may be stored in the storage unit 108 in advance, or may be transmitted from another device.

Also, the number of features to be extracted from an input image may be one or more. The process of extracting each feature from an input image may be performed by the recognition unit 150, for example. The feature dictionary includes a combination of an object ID for identifying an object and a feature of an object image, and the number of the combinations may be one or more. In the following, an explanation will be mainly given on an example where an object Obj is recognised as the object shown in an input image, but more than one object shown in an input image may be recognised. The recognition unit 150 outputs the recognition result to the display control unit 160.

More specifically, the recognition unit 150 extracts a feature point within an input image according to any know method such as a FAST feature detection method, for example. Then, the recognition unit 150 checks a feature point which has been detected against a vertex of an object included in the feature dictionary. As a result, the recognition unit 150 recognises which object is shown in the input image and at which position and with what attitude each object which has been recognised is shown.

In the case an object which has been recognised is an object included in a real space model, the three-dimensional position and attitude of the object is shown in the real space mode. In the case the object which has been recognised is an object included in an object model, the three-dimensional position and attitude of the object may be obtained by converting, according to a pinhole model, the two-dimensional position of a group of vertices of the object on an image plane into a three-dimensional position in the real space (for example, see JP 2008-304268A).

In the case a recognition method with a lower processing cost is selected by the selection unit 140, the recognition unit 150 recognises an object Obj shown in an input image by using the recognition method with a lower processing cost. Also, in the case a recognition method with a higher processing cost is selected by the selection unit 140, the recognition unit 150 recognises an object Obj shown in an input image by using the recognition method with a higher processing cost. These two recognition methods (the recognition method with a lower processing cost and the recognition method with a higher processing cost) may differ in the processing cost because of algorithms for extracting a feature from an input image being different or because of the amount of data to be checked being different. In the following, an explanation will be given mainly on an example where the processing cost is different for the two recognition methods because of the amount of data to be checked being different.

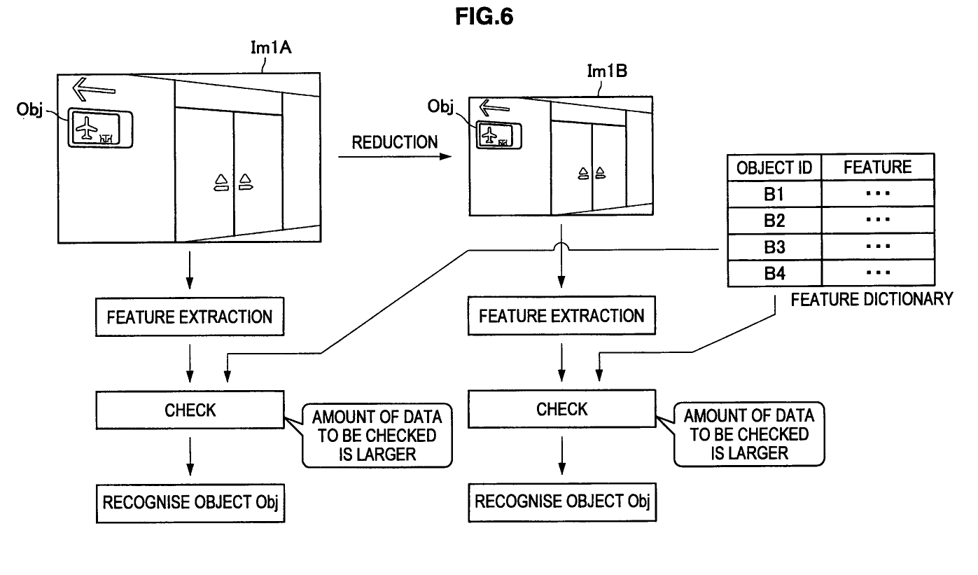

FIG. 6 is a diagram for describing a first example regarding a plurality of recognition methods. As shown in FIG. 6, in the case the recognition method with a lower processing is selected by the selection unit 140, the recognition unit 150 can reduce the size of an input image Im1A and extract each feature to be checked against the feature dictionary from an image Im1B after reduction, for example. Then, the recognition unit 150 can recognise an object Obj shown in the input image by checking each feature which has been extracted against the feature dictionary.

On the other hand, in the case the recognition method with a higher processing cost is selected by the selection unit 140, the recognition unit 150 can extract each feature to be checked against the feature dictionary from the input image Im1A without reducing the size of the input image Im1A, for example. Then, the recognition unit 150 can recognise an object Obj shown in the input image by checking each feature which has been extracted against the feature dictionary.

As described, in the first example regarding a plurality of recognition methods, in the case the recognition method with a lower processing cost (a first recognition method) is selected by the selection unit 140, the recognition unit 150 can extract each feature from an image with a smaller size. Accordingly, in the case the recognition method with a lower processing cost is selected by the selection unit 140, because the amount of data to be checked becomes smaller, the recognition unit 150 can recognise an object Obj shown in the input image by using the recognition method with a lower processing cost.

Additionally, here, it is assumed that the recognition unit 150 reduces the size of the input image Im1A in the case the recognition method with a lower processing cost is selected by the selection unit 140, but does not reduce the size of the input image Im1A in the case the recognition method with a higher processing cost is selected by the selection unit 140. However, it is not limited to such an example, and in the case the recognition method with a lower processing cost is selected by the selection unit 140, each feature may be extracted from an image with a smaller size compared to when the recognition method with a higher processing cost is selected by the selection unit 140.

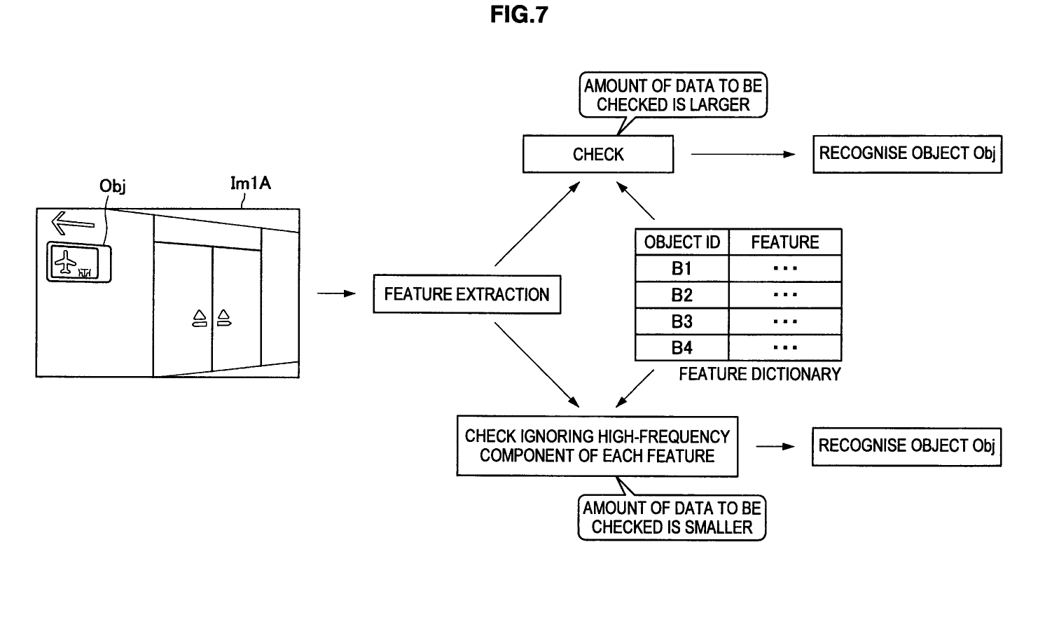

FIG. 7 is a diagram for describing a second example regarding a plurality of recognition methods. As shown in FIG. 7, in the case the recognition method with a lower processing cost is selected by the selection unit 140, the recognition unit 150 can extract each feature from the input image Im1A, ignore a high-frequency component of each feature which has been extracted and also a high-frequency component of the feature dictionary, and check each feature against the feature dictionary. For example, the recognition unit 150 cuts off a part exceeding a predetermined frequency as a high-frequency component, in each feature extracted from the input image Im1A and each feature of the feature dictionary. The recognition unit 150 can recognise an object Obj shown in the input image based on such a check.

On the other hand, in the case the recognition method with a higher processing cost is selected by the selection unit 140, the recognition unit 150 can extract each feature from the input image Im1A, and check each feature which has been extracted against the feature dictionary. The recognition unit 150 can recognise an object Obj shown in the input image based on such a check.

As described, in the second example regarding a plurality of recognition methods, in the case the recognition method with a lower processing cost (a second recognition method) is selected by the selection unit 140, the recognition unit 150 can check each feature while ignoring the high-frequency component of each feature. Accordingly, in the case the recognition method with a lower processing cost is selected by the selection unit 140, because the amount of data to be checked becomes smaller, the recognition unit 150 can recognise an object Obj shown in the input image by using the recognition method with a lower processing cost.

Additionally, here, it is assumed that the recognition unit 150 performs a check ignoring the high-frequency component of each feature extracted from the input image Im1A and each feature of the feature dictionary in the case the recognition method with a lower processing cost is selected by the selection unit 140. However, it is not limited to such an example, and in the case the recognition method with a lower processing cost is selected by the selection unit 140, a frequency component of a wider range may be cut off from each feature compared to when the recognition method with a higher processing cost is selected by the selection unit 140.

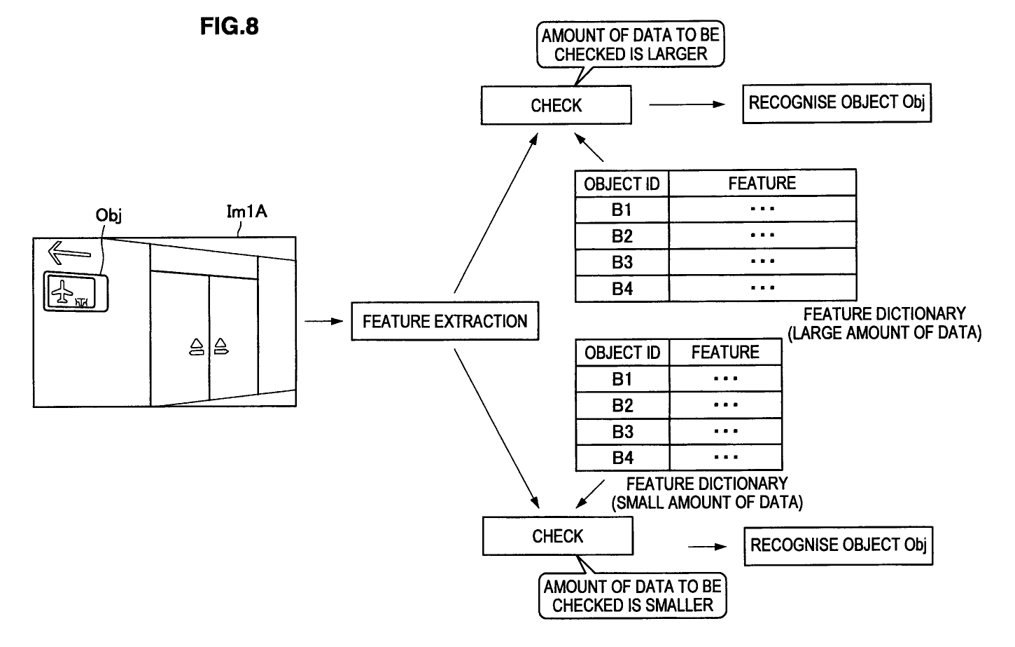

FIG. 8 is a diagram for describing a third example regarding a plurality of recognition methods. As shown in FIG. 8, in the case the recognition method with a lower processing cost is selected by the selection unit 140, the recognition unit 150 can extract each feature from the input image Im1A and check each feature which has been extracted against a feature dictionary with a smaller amount of data. The recognition unit 150 can recognise an object Obj shown in the input image by such a check.

On the other hand, in the case the recognition method with a higher processing cost is selected by the selection unit 140, the recognition unit 150 can extract each feature from the input image Im1A and check each feature which has been extracted against a feature dictionary with a larger amount of data. The recognition unit 150 can recognise an object Obj shown in the input image by such a check.

As described, in the third example regarding a plurality of recognition methods, in the case the recognition method with a lower processing cost (a third recognition method) is selected by the selection unit 140, the recognition unit 150 can perform a check using a feature dictionary with a smaller amount of data. Accordingly, in the case the recognition method with a lower processing cost is selected by the selection unit 140, because the amount of data to be checked becomes smaller, the recognition unit 150 can recognise an object Obj shown in the input image by using the recognition method with a lower processing cost.

Additionally, expressions such as a “feature dictionary with a larger amount of data” and a “feature dictionary with a smaller amount of data” merely express a size of the amount of data of a feature dictionary with respect to a relative relationship, and do not indicate an absolute size of the amount of data. That is, it means that, when comparing the amount of data of two feature dictionaries, the amount of data of one feature dictionary is smaller than the amount of data of the other feature dictionary.

[3-5. Flow of Recognition Process]

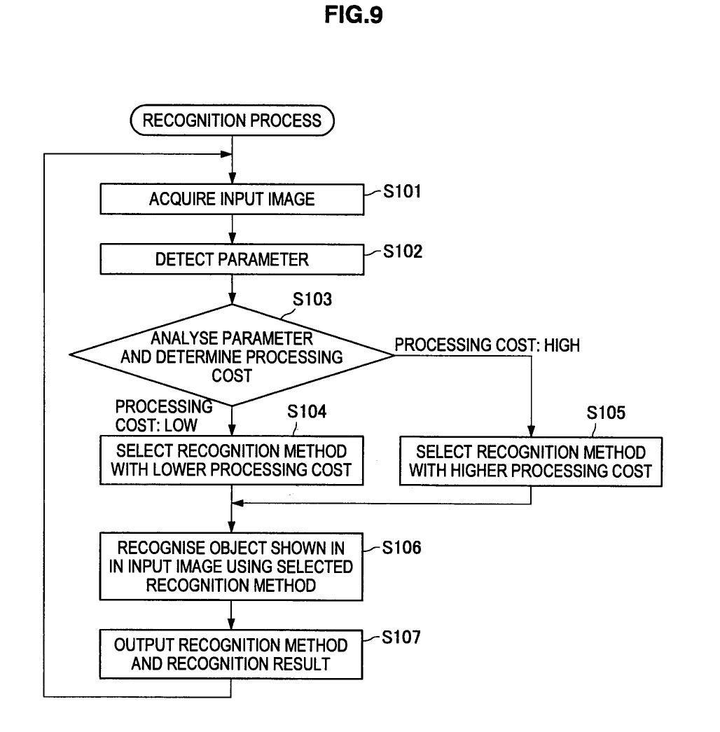

FIG. 9 is a flow chart showing a flow of a recognition process of an object. A flow of a recognition process of an object will be described with reference to FIG. 9.

As shown in FIG. 9, first, the image acquisition unit 120 acquires an input image showing a real space captured using the imaging unit 102 (or other imaging device) (S101). Also, the detection unit 130 detects a parameter regarding a motion of an object shown in the input image input from the image acquisition unit 120 (S102).

Next, the selection unit 140 analyses the parameter and determines the processing cost (S103). In the case it is determined that a recognition method with a lower processing cost is to be selected (S103; “processing cost: low”), the selection unit 140 selects a recognition method with a lower processing cost (S104). On the other hand, in the case it is determined that a recognition method with a higher processing cost is to be selected (S108; “processing cost: high”), the selection unit 140 selects a recognition method with a higher processing cost (S105).

Then, the recognition unit 150 recognises an object shown in the input image using the recognition method selected by the selection unit 140 (S106). The selection unit 140 outputs the selected recognition method to the display control unit 160, and the recognition unit 150 outputs the recognition result to the display control unit 160 (S107). The control unit 118 returns to acquiring an input image (S101), and the process from image acquisition by the image acquisition unit 120 (S101) to output of a recognition method and a recognition result (S107) is performed again.

[3-6. Display Control Unit]

The display control unit 160 superimposes a virtual object associated with an object recognised by the recognition unit 150 onto an input image and displays the same. With respect to a virtual object, data in which an object ID and virtual object data are associated is stored in the storage unit 108, for example. That is, the display control unit 160 can acquire from the storage unit 108 virtual object data associated with an object ID acquired by the recognition unit 150, and display a virtual object based on the acquired virtual object data.

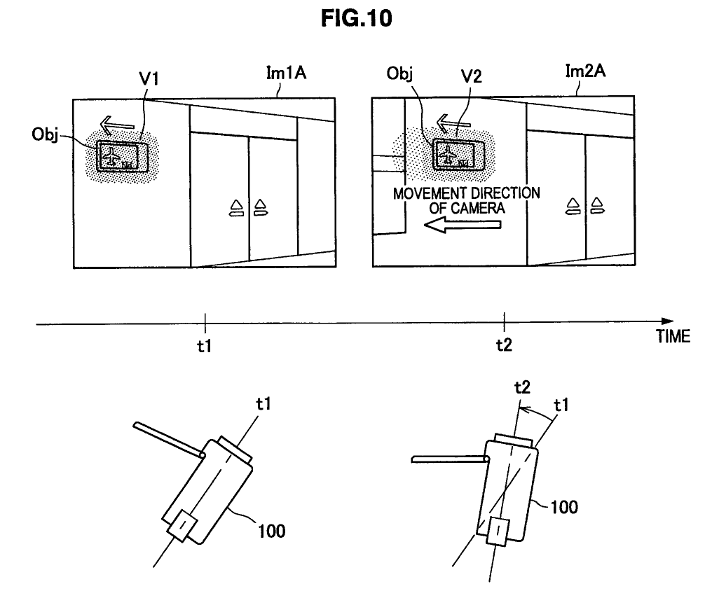

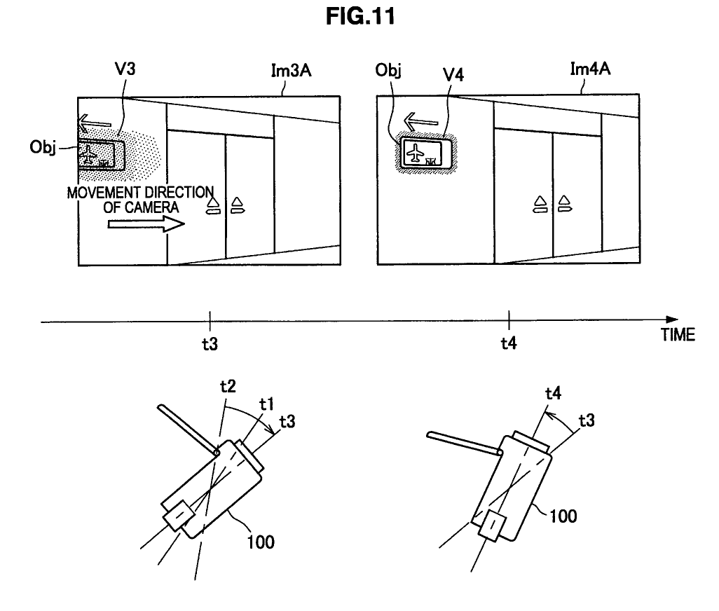

FIGS. 10 and 11 are diagrams showing example displays of a virtual object according to recognition methods selected by the selection unit 140. As shown in FIG. 10, the display control unit 160 can superimpose a virtual object associated with an object recognised by the recognition unit 150 onto an input image Im1A and display the same. Furthermore, the display control unit 160 may display the virtual object at whichever position and with whatever attitude. For example, the display control unit 160 may display the virtual object at the position of the object (or in the periphery of the object) acquired by the recognition unit 150 and with the attitude acquired by the recognition unit 150.

For example, in the case a recognition method with a lower processing cost is selected by the selection unit 140, because an object Obj shown in the input image Im1A is recognised by the recognition unit 150 using a recognition method with a lower processing cost, the display control unit 160 may reduce the clarity of display of the virtual object. In the example shown in FIG. 10, at time t1, a recognition method with a lower processing cost is selected by the selection unit 140 as the recognition method of an object shown in the input image Im1A and a less clear virtual object V1 is displayed by the display control unit 160.

Then, as shown in FIG. 10, it is assumed that the user moved, at time t2, the direction of the image processing apparatus 100 to the left. In this case, a recognition method with a lower processing cost is expected to be selected by the selection unit 140, thereby enabling the display control unit 160 to further reduce the clarity of the display of the virtual object. In the example shown in FIG. 10, at time t2, a recognition method with a lower processing cost is selected by the selection unit 140 as the recognition method of an object shown in an input image Im2A and a less clear virtual object V2 is displayed by the display control unit 160.

In the case a recognition method with a lower processing cost is selected by the selection unit 140, the display control unit 160 may display an afterimage of the virtual object. In the example shown in FIG. 10, at time t2, a recognition method with a lower processing cost is selected by the selection unit 140 as the recognition method of the object shown in the input image Im2A and an afterimage of the virtual object V1 is displayed by the display control unit 160. In this manner, by causing an afterimage of the virtual object V1 displayed in the past to be displayed together with the virtual object V2, the user, who saw the afterimage, can reverse the direction of the image processing apparatus 100 and restore the display position of the object Obj to a desired position.

Then, as shown in FIG. 11, it is assumed that the user moved the direction of the image processing apparatus 100 to the right at time t3. In this case, a recognition method with a lower processing cost is expected to be selected by the selection unit 140, thereby enabling the display control unit 160 to further reduce the clarity of the display of the virtual object. In the example shown in FIG. 11, at time t3, a recognition method with a lower processing cost is selected by the selection unit 140 as the recognition method of an object shown in an input image Im3A and a less clear virtual object V3 is displayed by the display control unit 160.

Additionally, also at time t3, a recognition method with a lower processing cost is selected by the selection unit 140 as the recognition method of the object shown in the input image Im3A and an afterimage of the virtual object V2 is displayed by the display control unit 160. In this manner, by causing an afterimage of the virtual object V2 displayed in the past to be displayed together with the virtual object V3, the user, who saw the afterimage, can reverse the direction of the image processing apparatus 100 and restore the display position of the object Obj to a desired position.

Then, as shown in FIG. 11, it is assumed that the user fixed the direction of the image processing apparatus 100 at time t4. In this case, a recognition method with a higher processing cost is expected to be selected by the selection unit 140, thereby enabling the display control unit 160 to increase the clarity of the display of the virtual object. In the example shown in FIG. 11, at time t4, a recognition method with a higher processing cost is selected by the selection unit 140 as the recognition method of an object shown in an input image Im4A and a clearer virtual object V4 is displayed by the display control unit 160.

As described, the display control unit 160 can change the display of a virtual object according to the recognition method selected by the selection unit 140. According to such control, a user is enabled to perceive the recognition method of an object that is associated with a virtual object.

[3-7. Flow of Display Control Process]

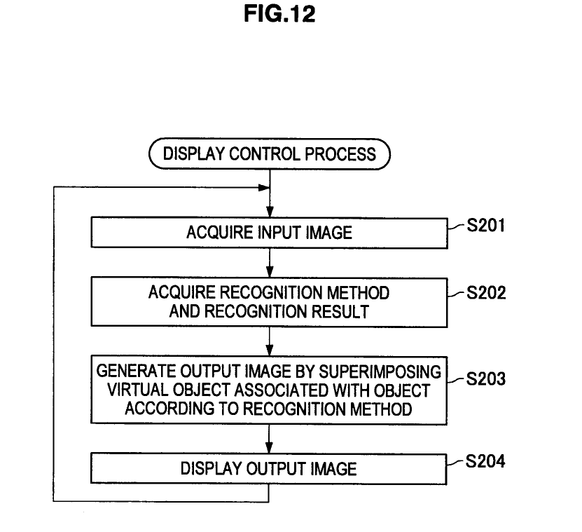

FIG. 12 is a flow chart showing a flow of a display control process of an output image. A flow of a display control process of an output image will be described with reference to FIG. 12.

As shown in FIG. 12, first, the display control unit 160 acquires an input image from the image acquisition unit 120 (S201). Also, the display control unit 160 acquires a recognition method output by the selection unit 140 and a recognition result output by the recognition unit 150 (S202). Next, the display control unit 160 generates an output image by superimposing, according to the recognition method, a virtual object that is associated with an object which has been recognised onto the input image (S203). Then, the display control unit 160 displays the output image (S204). The control unit 118 returns to acquiring an input image (S201), and the process from image acquisition by the image acquisition unit 120 (S201) to output of an output image (S204) is performed again.

<4. Summary>

As described above, according to the embodiment of the present disclosure, the image processing apparatus can enable a user to perceive the recognition method of an object that is associated with a virtual object. A user can thereby perceive, when looking at a virtual object that is displayed, for example, with what level of processing cost recognition of an object that is associated with the virtual object has been performed. As has been described, the clarity of a virtual object may be changed based on the recognition method, for example.

Furthermore, according to the embodiment of the present disclosure, the image processing apparatus can cause an afterimage of a virtual object displayed in the past to be displayed together with a virtual object that is associated with an object that is currently recognised. A user who has seen the afterimage can thereby reverse the direction of the image processing apparatus and restore the display position of the object to a desired position.

It should be understood by those skilled in the art that various modifications, combinations, sub-combinations and alterations may occur depending on design requirements and other factors insofar as they are within the scope of the appended claims or the equivalents thereof.

For example, the steps of the processing of the image processing apparatus according to the present specification do not necessarily have to be processed chronologically according to the order described as the flow chart. For example, the steps of the processing of the image processing apparatus can also be processed in an order different from that described as the flow chart or may be processed in parallel.

Furthermore, the series of control processes by the image processing apparatus described in the present specification may be realized by using software, hardware or a combination of software and hardware. Programs constituting the software are stored in advance in a storage medium provided inside or outside each device. Each program is read by a RAM (Random Access Memory) at the time of execution and executed by a processor such as a CPU (Central Processing Unit), for example.

Additionally, the present technology may also be configured as below.
(1) An image processing apparatus including:

an image acquisition unit for acquiring an input image;

a selection unit for selecting a recognition method of an object shown in the input image from a plurality of recognition methods;

a recognition unit for recognising the object shown in the input image using the recognition method selected by the selection unit; and

a display control unit for superimposing a virtual object that is associated with the object recognised by the recognition unit onto the input image and displaying the virtual object,

wherein the display control unit changes display of the virtual object according to the recognition method selected by the selection unit.
(2) The image processing apparatus according to (1), wherein the recognition unit recognises the object shown in the input image by checking a feature extracted from the input image against a feature dictionary, which is a collection of features of a known object image.
(3) The image processing apparatus according to (1) or (2), wherein the plurality of recognition methods are methods for which amounts of data to be checked by the recognition unit are different.
(4) The image processing apparatus according to any one of (1) to (3), wherein the recognition unit extracts, according to a first recognition method, a feature to be checked against the feature dictionary from the input image whose size has been reduced.
(5) The image processing apparatus according to any one of (1) to (3), wherein the recognition unit checks, according to a second recognition method, a feature while ignoring a high-frequency component of each feature.
(6) The image processing apparatus according to any one of (1) to (3), wherein the recognition unit uses, according to a third recognition method, a feature dictionary with a smaller amount of data among a plurality of feature dictionaries.
(7) The image processing apparatus according to (2), wherein the plurality of recognition methods are methods for which extraction algorithms for the feature of the recognition unit are different.
(8) The image processing apparatus according to any one of (1) to (7), further including:

a detection unit for detecting a parameter regarding a motion of the object shown in the input image,

wherein, in a case the parameter detected by the detection unit indicates that an object moving at a level exceeding a predetermined level is shown in the input image, the selection unit selects a recognition method with a lower processing cost.
(9) The image processing apparatus according to (8), wherein the parameter is a parameter that is in accordance with an amount of relative movement between the image processing apparatus and the object shown in the input image.
(10) The image processing apparatus according to (8), wherein the parameter is a parameter that is in accordance with an amount of absolute movement of the image processing apparatus.
(11) The image processing apparatus according to any one of (1) to (10), wherein the display control unit changes clarity of display of the virtual object according to the recognition method selected by the selection unit.
(12) The image processing apparatus according to any one of (1) to (11), wherein, in a case a recognition method with a lower processing cost is selected by the selection unit, the display control unit causes an afterimage of the virtual object to be displayed.
(13) An image processing method including:

acquiring an input image;

selecting a recognition method of an object shown in the input image from a plurality of recognition methods;

recognising the object shown in the input image using the selected recognition method;

superimposing a virtual object that is associated with the recognised object onto the input image and displaying the virtual object; and

changing display of the virtual object according to the selected recognition method.
(14) A program for causing a computer to function as an image processing apparatus including:

an image acquisition unit for acquiring an input image;

a selection unit for selecting a recognition method of an object shown in the input image from a plurality of recognition methods;

a recognition unit for recognising the object shown in the input image using the recognition method selected by the selection unit; and

a display control unit for superimposing a virtual object that is associated with the object recognised by the recognition unit onto the input image and displaying the virtual object,

wherein the display control unit changes display of the virtual object according to the recognition method selected by the selection unit.

The present disclosure contains subject matter related to that disclosed in Japanese Priority Patent Application JP 2011-093089 filed in the Japan Patent Office on Apr. 19, 2011, the entire content of which is hereby incorporated by reference.

What is claimed is:

1. An image processing apparatus comprising:
an image acquisition unit for acquiring an input image;
a selection unit for selecting a recognition method of an object shown in the input image from a plurality of recognition methods;
a recognition unit for recognising the object shown in the input image using the recognition method selected by the selection unit; and
a display control unit for superimposing a virtual object that is associated with the object recognised by the recognition unit onto the input image and displaying the virtual object,
wherein the display control unit changes display of the virtual object according to the recognition method selected by the selection unit.

2. The image processing apparatus according to claim 1, wherein the recognition unit recognises the object shown in the input image by checking a feature extracted from the input image against a feature dictionary, which is a collection of features of a known object image.

3. The image processing apparatus according to claim 2, wherein the plurality of recognition methods are methods for which amounts of data to be checked by the recognition unit are different.

4. The image processing apparatus according to claim 3, wherein the recognition unit extracts, according to a first recognition method, a feature to be checked against the feature dictionary from the input image whose size has been reduced.

5. The image processing apparatus according to claim 3, wherein the recognition unit checks, according to a second recognition method, a feature while ignoring a high-frequency component of each feature.

6. The image processing apparatus according to claim 3, wherein the recognition unit uses, according to a third recognition method, a feature dictionary with a smaller amount of data among a plurality of feature dictionaries.

7. The image processing apparatus according to claim 2, wherein the plurality of recognition methods are methods for which extraction algorithms for the feature of the recognition unit are different.

8. The image processing apparatus according to claim 1, further comprising:
a detection unit for detecting a parameter regarding a motion of the object shown in the input image,
wherein, in a case the parameter detected by the detection unit indicates that an object moving at a level exceeding a predetermined level is shown in the input image, the selection unit selects a recognition method with a lower processing cost.

9. The image processing apparatus according to claim 8, wherein the parameter is a parameter that is in accordance with an amount of relative movement between the image processing apparatus and the object shown in the input image.

10. The image processing apparatus according to claim 8, wherein the parameter is a parameter that is in accordance with an amount of absolute movement of the image processing apparatus.

11. The image processing apparatus according to claim 1, wherein the display control unit changes clarity of display of the virtual object according to the recognition method selected by the selection unit.

12. The image processing apparatus according to claim 1, wherein, in a case a recognition method with a lower processing cost is selected by the selection unit, the display control unit causes an afterimage of the virtual object to be displayed.

13. An image processing method comprising:
acquiring an input image;
selecting a recognition method of an object shown in the input image from a plurality of recognition methods;
recognising the object shown in the input image using the selected recognition method;
superimposing a virtual object that is associated with the recognised object onto the input image and displaying the virtual object; and
changing display of the virtual object according to the selected recognition method.

14. A program for causing a computer to function as an image processing apparatus including:
an image acquisition unit for acquiring an input image;
a selection unit for selecting a recognition method of an object shown in the input image from a plurality of recognition methods;
a recognition unit for recognising the object shown in the input image using the recognition method selected by the selection unit; and
a display control unit for superimposing a virtual object that is associated with the object recognised by the recognition unit onto the input image and displaying the virtual object,
wherein the display control unit changes display of the virtual object according to the recognition method selected by the selection unit.
